(19) United States
(12) Patent Application Publication
(10) Pub. No.: US 2014/0012772 A1
(43) Pub. Date: Jan. 9, 2014

(54) LOGISTICS SOURCING IMPROVEMENTS

(71) Applicant: Kurt Pretorius, Victoria (AU)

(72) Inventor: Kurt Pretorius, Victoria (AU)

(73) Assignee: PRETORIUS IP HOLDINGS PTY LTD, Mulgrave, Victoria (AU)

(21) Appl. No.: 14/006,903

(22) PCT Filed: Mar. 11, 2012
(86) PCT No.: PCT/AU2012/000241

§ 371 Date: Sep. 23, 2013

Related U.S. Application Data
(60) Provisional application No. 61/468,064, filed on Mar. 27, 2011.
(60) Provisional application No. 61/505,108, filed on Jul. 6, 2011.

(30) Foreign Application Priority Data
Mar. 24, 2011 (AU) 2011901082

(51) Int. Cl. G06Q 10/08

(52) U.S. Cl. CPC G06Q 10/08
USPC 705/330

(57) ABSTRACT

The present invention provides methods and systems of identifying suppliers of applicable modes of transport that meet specified business requirements, providing a means to compare and evaluate these suppliers. Some forms of the invention provide computer-based methods for assisting a logistics decision of a potential customer, the method comprising the steps of: receiving at least one logistics related requirement from the potential customer, calculating at least one suitable logistics option from a plurality of supplier-provided logistic options, and providing an output of at least one logistics option in a form readable by the potential customer. Logistics-related requirements include a preferred or required origin point, a preferred or required destination point, a preferred or required mode of transport, a preferred or required travel time, a preferred or required delivery date, a preferred or required environmental impact caused by the logistic, a preferred or required cost, a preferred or required payment method or term, a preferred or required accreditation of a supplier, or a preferred or required level of operational performance of a supplier.

This application claims priority from the following provisional patent applications, the specifications of which are incorporated herein by reference: Australia; AU2011/901082; U.S. 61/468,064; U.S. 61/505,108.

### BACKGROUND OF THE INVENTION

There exists businesses that require logistics services or quotations on existing business requirements that use logistics or transport services on a consistent basis because these businesses are not occasional shippers.

While the prior art provides many means for assisting business seeking logistics solutions, all have at least one disadvantage.

Many businesses are contacted directly by transport providers to solicit their business even though the business may not be seeking quotes from a transport company. Transport companies employ various types of sales forces, internal and or external, to canvas businesses as to whether or not the businesses require their services. This is and was a costly practice as the conversion rate of such exercises is very low.

A business may utilize a directory of transport providers, however the problem with this approach is that the business does all the work, and must call a number of providers for quotes.

Often, decisions are made purely on price at the sacrifice of service. This task becomes increasingly difficult when there are tens of thousands of registered road transport providers.

Increasingly, businesses are using internet search engines to find and research logistics or transport providers. Unfortunately, the results often provided by such search engines are often served up based on paid preferential listing, and therefore not necessarily on the best fit to the user's enquiry. In addition, if users do not use the best search expressions they may not receive the best results from their query.

Businesses that are initially successful in identifying internet sites providing directories of contact information of logistics or transport providers, may then encounter another problem. There is the difficulty of knowing which service providers meets all the requirements, of easily short listing the best providers who may meet your requirements and finally, or of collating the voluminous information in an easy and time efficient manner. This problem is similar to that experienced when reviewing business contact details in hard copy publications mentioned earlier.

Logistics procurement software may also be used but this software is expensive to purchase and often difficult for the lay person to use.

At present, logistics service providers also suffer a number of disadvantages in finding new business. This is compounded by the fact that there are a large number of businesses competing for the same customers, also the fact that using conventional sales methods i.e. cold calling is the most cost and time effective method of finding and attracting new clients. Timing is also an import part to signing new business as most of the time sales representatives call on a customer they are satisfied with their current incumbent or provider. A significant problem is the cost of maintaining a sales force, whereby staff typically spend approximately 80% of their time identifying new business leads.

The reference to any prior art in this specification is not, and should not be taken as, an acknowledgement or any form of suggestion that the prior art forms part of the common general knowledge.

### SUMMARY OF THE INVENTION

Throughout this specification (including any claims which follow), unless the context requires otherwise, the word ‘comprise’, and variations such as ‘comprises’ and ‘comprising’, may be understood to imply the inclusion of a stated integer or step or group of integers or steps but not the exclusion of any other integer or step or group of integers or steps.

In one aspect, the present invention provides a computer-based method for assisting a logistics decision of a potential customer, the method comprising the steps of: receiving at least one logistics related requirement from the potential customer, calculating at least one suitable logistics option from a plurality of supplier-provided logistic options, and providing an output of at least one logistics option in a form readable by the potential customer.

In one embodiment of the method, the at least one logistics-related requirement is selected from the group consisting of: a preferred or required origin point, a preferred or required destination point, a preferred or required mode of transport, a preferred or required travel time, a preferred or required delivery date, a preferred or required environmental impact caused by the logistic, a preferred or required cost, a preferred or required payment method or term, a preferred or required accreditation of a supplier, and a preferred or required level of operational performance of a supplier.

In one embodiment, the method comprises the step of receiving a supplier-provided logistics option. The supplier-provided logistics option may be associated with a logistics-related parameter selected from the group consisting of: geographical operational area, a mode of transport, a travel time, an environmental impact caused by the logistic, a cost, a payment method or term, an accreditation, and operational performance information.

In another embodiment of the method the output displays a logistics option for 2, 3, 4, 5, 6 or more modes of transport. In addition or alternatively, the output may display a logistics option for 2, 3, 4, 5, 6 or more suppliers in other embodiment.

In another embodiment of the computer-based method, the output displays a logistics-related parameter selected from the group consisting of: a geographical operational area, a mode of transport, a travel time, an environmental impact caused by the logistic, a cost, a payment method or term, an accreditation, and operational performance information.

In another embodiment, the customer readable form comprises a map displaying route options for two or more suppliers.

In one form of the method, the output is devoid of information allowing for identification of the supplier. In addition or alternatively, the method may be devoid of means for the potential customer to contact the supplier.

In another aspect of the present invention there is provided a computer-based method for matching a logistics supplier with a potential customer, the method comprising the steps of: receiving information related to the services of the logistics supplier, calculating at least one suitable potential customer option from a plurality of potential customer-provided logistics requirements, and providing an output of at least one potential customer option in a form readable by the supplier.

In one embodiment, the information related to the services of the logistics supplier is associated with a logistics-related parameter selected from the group consisting of: geographical operational area, a mode of transport, a travel time, an environmental impact caused by the logistic, a cost, a payment method or term, an accreditation, and operational performance information.

In one embodiment, the method comprises the step of receiving a customer-provided logistics requirement. In one embodiment, the information related to the customer-provided logistics requirement is selected from the group consisting of: a preferred or required origin point, a preferred or required destination point, a preferred or required mode of transport, a preferred or required travel time, a preferred or required delivery date, a preferred or required environmental impact caused by the logistic, a preferred or required cost, a preferred or required payment method or term, a preferred or required accreditation of a supplier, and a preferred or required level of operational performance of a supplier.

In one embodiment the output comprises information allowing the supplier to contact the potential customer. In one embodiment the output is information related to the potential customer selected from the group consisting of: a name, a physical address, an email address, and a telephone number.

In another embodiment the method comprises means for the potential customer to contact the supplier. In one embodiment the potential customer is not provided with information allowing for the identification of the supplier.

In one embodiment of the computer-based method, the method comprises the step of the supplier providing a payment for the output. In addition or alternatively, the method comprises the step of providing means for the supplier to provide a payment for the output.

In one aspect of the invention there is provided a method for assisting a logistics decision comprising receiving at least one logistics related requirement, calculating at least one logistics option and providing the option in a user readable form.

In another aspect, the invention provides a system for assisting a logistics decision, comprising: a receiving network for communicating a logistics related requirement from a user; a processor connected to the network and configured for calculating at least one logistics option; and a user interface to communicate at least one logistics option to a user.

The description herewith offers unique capabilities for businesses to source and compare logistics companies as well as the opportunity to providing these capabilities via online service that matches business logistics requirements to that of logistics service providers (LSPs). The solution comprises a sophisticated tool that provides applicable alternative transport modes for the transport of goods to and from two geographic locations. The system allows user to download spread sheet template to fill in the information and upload the same. The system then collects information from spread sheet and stores each item into corresponding fields in the database. The tool calculates time, distance and environmental impact of the route based on the origin and destination locations. The business user may then identify what modes of transport, if provided by the tool, i.e. rail, road, air or sea they want to use to ship their products. Thus it provides for global searching, intra and interstate searching in respect of any two geographical locations and enable users to explore logistic (hiring and providing) even in places about which users are not well informed. Once the business user has finished entering their route information and identified which modes they want to ship their freight by (or obtain quotes for), their quote information may be sent to applicable transport providers who may purchase the sales lead information and provide the necessary quote to the business. This process saves the business time and effort in sourcing logistics or transport quotes and provides a wealth of information to help compare respondents. The tool also allows quoted business requirements to be saved for re-quoting in the future.

From a supplier perspective, the solution presented herewith may provide leads in a timely manner, that are qualified and at a reasonable price, providing a much lower cost of acquisition than that offered by the efforts of their sales force.

In another aspect, the invention provides a system that may be linked directly to other websites or systems so that space may be purchased. For example a franchise company may add a link/frame so that members may access the system without leaving the franchise main website. They may then log in and buy directly from the system. B2B companies may be able to utilise this system to find logistics services for their clients. Preferably the method includes linking a system for performing the method with a third party such that the third party appears to perform the method. In yet another aspect of the invention there is provided a method of and/or system for sourcing and managing logistics requirements, the method comprising:
i) receiving sets of logistics requirements; and ii) maintaining statistics on the sets of logistics information.

According to one more aspect of the invention there is provided a method for coordinating information for use in logistics sourcing, the method comprising:
i) receiving sets of logistics information associated with logistics requirements for business logistics needs;
ii) searching the stored sets of logistics information to locate at least one set that meets with business logistics criteria; and
iii) maintaining statistics of the sets of logistics information.

Preferably the step of maintaining statistics includes maintaining statistics of which of the stored sets of logistics information are being repetitively searched and maintaining statistics of which of the stored sets of logistics information are being repetitively purchased.

In one aspect the present also provides customers to share their logistics requirements with other people using social networking tools. The user/customer may have the ability to invite friends or colleagues for social networking sites to view their logistics requirements. The user/customer may have the ability to delegate certain permissions to these people at the time of invitation to join/view the logistics requirements.

In yet another aspect of the invention, there is provided a system to allow registered users to create a portfolio. These portfolios enable a business to create requirements for all their businesses specific transportation or logistics needs. Portfolios may be of various types and access to friends and colleagues may be provided. System may also provide a list of predefined Portfolio structures and configuration for different industries that may be used by users.

According to one more aspect of the invention, it provides a bidding system where customer may select lowest bid (quote) by an auction such as blind or revere auction. Suppliers may or may not be able to see the competitor's quotes as per the option selected by customer. The bidding may take place in number of rounds at the end of which lowest bid may be selected.

### BRIEF DESCRIPTION OF THE DRAWINGS

In the following advantageous implementations, the invention may be further described by means of examples and by means of the FIGs:

FIG. 1 shows a system overview of a platform based implementation of the invention;

FIG. 2 shows a functional view of implementations according to a preferred embodiment of the invention;

FIG. 3 shows advantageous files, tables and processes used in the calculation process;

FIG. 4 shows an example for the use of modal selection options for shipping freight from its origin to its destination and the calculation of carbon emissions and time for each leg;

FIG. 5 depicts an Operation Process Map

FIG. 6 depicts an Information Flow Map

FIGS. 1000-1900 depict screen shots according to one embodiment of the invention

FIG. 2000 depicts a screen shot of an input screen, as seen by a user.

FIG. 2100 depicts a screen shot of an output screen, as seen by a user.

### DETAILED DESCRIPTION OF EXEMPLARY EMBODIMENTS

It is convenient to describe the invention herein in relation to particularly preferred embodiments relating the present solution. However, the solution is applicable to a wide range of industries and it is to be appreciated that other constructions and arrangements are also considered as falling within the scope of the invention. Various modifications, alterations, variations or additions to the construction and arrangements described herein are also considered as falling within the ambit and scope of the present solution.

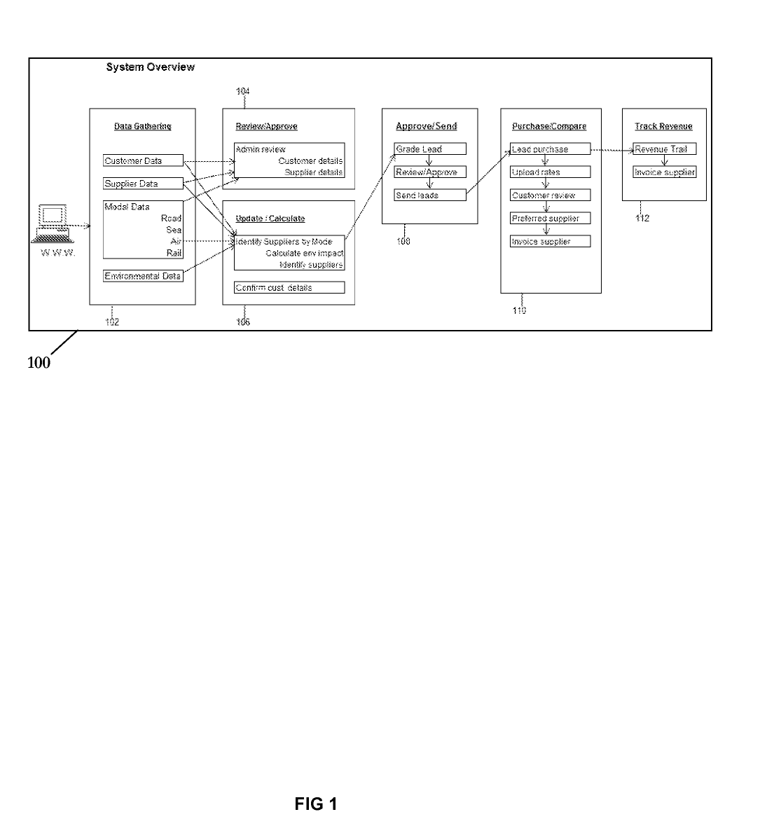

FIG. 1 shows a preferred system overview 100. The embodiment according to FIG. 1 contains six basic modules: a data gathering module 102, a review-approve module 104, an update-calculate module 106, an approve-send module 108, a purchase compare module 110, and a track revenue module 112.

The solution may be used by those offering logistics or transport services (“Suppliers”), and, those seeking the service of logistics or transport services for more than just one off shipments (“Customers”). Both parties may need to register to be users the using data gathering module 102. An embodiment of the data gathering module may be an online interface via the internet. A site administrator may review the registration details for completeness prior to sending confirmation emails to both parties which contains their login information 104.

Once registered, Suppliers may be able to enter all of their applicable business information including information about their financial performance, technology offered, service diversification, client diversification, operational performance and environmental management within the online interface of the data gathering module 102. Suppliers may also enter information about their ideal lead profile, so only the leads which best meet their ideal customer are sent to them.

Once registered, customers may then create or manage their freight quote portfolios using the online interface of the data gathering module 102. These portfolios enable a business to create requirements for all their business's specific transportation or logistics needs, for example, they may create portfolios for their palletised freight needs and carton freight needs. A list of predefined Portfolio structures and configuration for different industries may be made available (“Portfolios”). It is contemplated that by providing pre-defined structures, it may provide assistance to users and speed up their quoting process. For example, if the Customer was in the medical industry a Portfolio structure may be setup with a pre-configured requirement for express delivery and require refrigerated carriage of goods.

Each Portfolio may have different business requirements for each, aside from the dimensional information, they may travel by different modes. For example, cartonised freight may travel by air where as palletised freight may travel by all modes except for air. Customers may be able to specify requirements such as the type of bid event, either reverse auction or blind auction, urgency of their delivery, payment terms, to and from locations, and the like. An upload facility may be provided that enable customers to upload spreadsheets or Comma-Separated-Value (CSV) formatted files to enable faster input times, as often large shippers have hundreds of destinations they ship to. Following this, the system collects data from the spreadsheet and stores each item into corresponding fields in the database. Portfolios may be grouped into current, closed/past, all and friends/colleagues portfolios.

Current portfolios—list of currently open portfolios. This may provide information on the name of the portfolio, the status of the portfolio, the expected annual value of the spend for the transport for that business requirement, the current annual spend for the transport for the business requirement and relevant actions which allow you to view detailed information about the portfolio. These actions include, but are not limited to—view, map and delete. View enables the user to view the detailed requirements of the portfolio such as specified transport to ship, routes/lanes used, quantity of freight shipped, value of freight shipped per lane, business requirements such as technological requirements, payment terms, accreditations, operational performance, and the like. Map enables viewing the lanes specified on a mapping interface. The weighting of these lines on the map may have weighting for the volume of freight shipped. The Delete option may enable deletion of the portfolio, and the user may be prompted first prior to deletion of the portfolio. An option may also be provided to view freight transport providers who have purchased the customer's lead and the ability to view provided quotes to the customer. The customer may also use the supplier comparison functionality where all business data may be compared of these suppliers. This functionality may be provided for Closed portfolios and All portfolios. As businesses re-evaluate their rates on a regular basis (12 to 18 months on average) the facility exists so that customers may re-open existing/closed portfolios to request new quotes using the update—calculate module 106. The newly requested quotes may appear separately from the previous quotes.

Friends/Colleagues Portfolios may enable access to Friends/Colleagues Portfolios or grant others permission to access portfolios. The permissions may be granted to by Friends/Colleagues for each of their Portfolios as required. Alternatively, permission may be granted to Friends/Colleagues as desired. Social networking tools or application programming interfaces may enable users/customers of the website to access external systems such as social networks, such as Facebook or LinkedIn. These application programming interfaces may be used to allow the customer/user to invite friends/colleagues from their social networking sites such as LinkedIn or Facebook to access to their logistics portfolios. Upon acceptance of the invitation or logging into the website (FML) by the invitee, relevant information for these people may be retrieved from the social network, such as their photo, name, job title, employer company, and the like. At the time of generating the invitation permissions may be granted. These permissions may include delegated ownership where the Friends/Colleague provides ownership permission of the Portfolio, Read-Only access may enable the viewing, but not editing of Portfolio contents, Edit functionality allows for the editing of portfolio contents. It should be noted that this access is not limited to the permissions stated.

Individuals having access to portfolios may have their own profile pages which may outline personal information such as name, job title, contact information including email, phone numbers, linkedIn details, photo e, the portfolios they have access to, relevant permissions for those portfolios and the like. They may also receive a news feed of all the activity occurring within the portfolios for which the have access to enable them to keep up to date.

Members of portfolios may be able to communicate in such a manner that their communication is viewable as a group. Microblogging, real-time activity streams and instant email notifications about changes may enable the team to stay in touch with everything relating to the portfolios. This information may be viewable as a separate section on the portfolio detail or in personal profile pages. This detail may be reviewed in detail if desired. Alternatively, team members may communicate with people directly via email or similar from within the website.

Once the customer registers their portfolio details, the system may then identify the applicable alternative modes of transport that the customer could use to transport their freight using the update—calculate module 106. There are various factors that may determine which mode of transport to use, these include but are not limited to delivery time and cost. Generally the faster the freight gets to the destination the more it costs. Alternative modes of transport for each destination may be calculated as such based on the origin and destination and those suppliers that offer services in the applicable geographic areas and meet the customers other business requirements. Once the possible alternate modes of transport are identified, they are displayed to the user for selection. The customer then goes through and selects the shipping modal alternatives they want quotes for, for each route. With the calculation of each modal alternative asset utilised in each modal alternative option, shipping time, energy and emissions values may be calculated. These values may then be summed up to provide an overall time, emissions and energy consumption view of each alternative. The customer/user may compare the modes of transport analysing their impact to the environment, the time and environmental cost to ship via the specific modes.

An exemplary embodiment of the present invention facilitates determining the effect of transport processes on the environment.

Another exemplary embodiment of the present invention comprises generating and/or presenting reports on generated and/or expected emissions but not their effect on the environment.

A further exemplary embodiment of the present invention allows carrying out transport processes according to environmental requirements.

An exemplary embodiment of the present invention enables the following advantages: detailed emission reporting for a transport carrier or each single transport process, or reporting done on customer requirements basis

The customer may view their routes on a Google™ maps interface or similar. This may be achieved by plotting relevant geocode details from the modal tables and dynamically using the mapping functions of the mapping application. When a user hovers over each route on the maps the environmental information is shown in a call out box. The user may also have the ability to view the volume of shipments per route by clicking a radio button which displays the route using an online service provided by Google™ Map at http://maps.google.com. Depending on the volume of freight shipped, as indicated by the users input 102, the system may allow the Customer to visualize which routes are used most often or less frequently through the illustration lines of relative thickness that provide information on the other possible routes and their volumes shipped. Once the Customer has selected the modes a confirmation email is sent with a quotation via the update or calculate module. If there are any changes to this information the user may follow the link in the email or log into their account to make any necessary changes. If additional routes need quoting they may go through the same process again where lead emails may be sent to suppliers, and suppliers may respond in turn. It is advantageous to provide the ability to block leads sent to suppliers who have already purchased the quotes previously. If routes need to be removed these changes may be sent to the suppliers who have purchased the leads or to all suppliers who meet the criteria.

The customer may also have an option to request quotes from providers who may service all legs and modes of transport for a given modal option (road, rail, air or sea), or the customer may elect to get different providers for different transport legs. For example, some transport providers may provide drayage (the transport of goods a short distance) to an intermodal transport site, the intermodal transport component (transport via train, ship or plane) and then the drayage to the destination. Alternatively, some transport providers may only provide services for individual legs of the journey; i.e. two drayage providers in separate states may be used and another provider for the intermodal component.

Also, an indicator may be provided that makes use of the current price of oil. The price of oil has an impact on the price of fuel, and when the price of fuel increases higher costs are passed onto road freight transport users. In this case, modal alternatives such as rail may be a more attractive option to a freight transport customer. An indicator on the website may indicate that rail supplier options may offer cost savings to the customer, in that case the customer may be more inclined to select a modal alternative that utilises rail, for example. Other indicators relating to time savings and cost savings may be included in, for example, the modal selection section of a screen displaying quotes.

Once the customer quote request is received, the quote is graded according to a specification to determine the quote's completeness, relevant grading by the approve send module 108. These gradings enable the operator to determine how complete the quote is without reviewing the entire quote. With this information a user may determine the amount of work required to bring it up to an acceptable standard before passing it on to suppliers.

According to the grading and the buying indicator specified by the customer, the quote request is then graded in Customer Relationship Model (CRM) terms. i.e. contact, suspect, lead, qualified lead, prospect, and the like, by the rating module 5108. It should be noted that the CRM terms are not limited to these gradings. The grading plus a colour indicator which may be displayed on the header of the lead which aligns to the graded CRM term may provide an indicator of the customer's intention to buy. The intent to buy gives the person buying the lead an indication of the willingness of the customer to buy services.

Pending the quote release in the approve-send module 108 the administrator may firstly inspect the customer's business details and business requirements for completeness following up on the information identified in the grading process as not been present. Once updated the quote may then be re-graded to update the grade of the lead as mentioned above, if satisfied the administrator may release the quote to all suppliers who meet the requirements of the customer.

Suppliers may then receive a lead email 110, where the supplier may receive all the details about the customer's job including the customers buying intention and purchasing timeframe. Any information that may identify the customer may not be provided. The supplier has to purchase the lead using the purchase-compare module 110 first before receiving this information. The supplier may follow the link in the email to the website or login directly to purchase the lead. Once purchased they may be sent an email with all the job and customer details. The supplier is then billed in the backend of the system for the value of the lead as specified in the membership package they've selected. It may also be advantageous in some embodiments to provide a system for tracking trailing income from a supplier, where the supplier is billed a certain percentage of the revenue generated after one year of trade by the customer.

The supplier may have the ability to manage all purchased leads. The supplier may be able to send the lead to applicable people within their company for follow up. These leads may be monitored and tracked through various stages to better manage them.

For each supplier who purchases a lead, an email may be sent to the customer notifying them that a representative from the supplier's organisation may be contacting them. The customer may then review the five star ratings for the supplier, their referrals and personal business page to help them make a decision on suitability. It is also contemplated that suppliers may be able to upload their rates for the specified routes to enable comparison of rates per route via spreadsheet or data file. Following this the system collects the data from the spreadsheet and stores each item into corresponding fields in the database. In some embodiments, this may be advantageous for customers when comparing rates from various suppliers. This information may be available for each provider by each mode specified by the customer.

The supplier may be invoiced monthly for all leads purchased and on a pre-determined basis for trailing income.

Customers may also have the ability to run reports, these reports would be able to be output via pdf and excel formats.

Other aspects of the site's functionality include the ability to add team members so they may administer portfolios as well using the update-calculate module 106. These members may have different abilities to read, write and delete information from the specified portfolios.

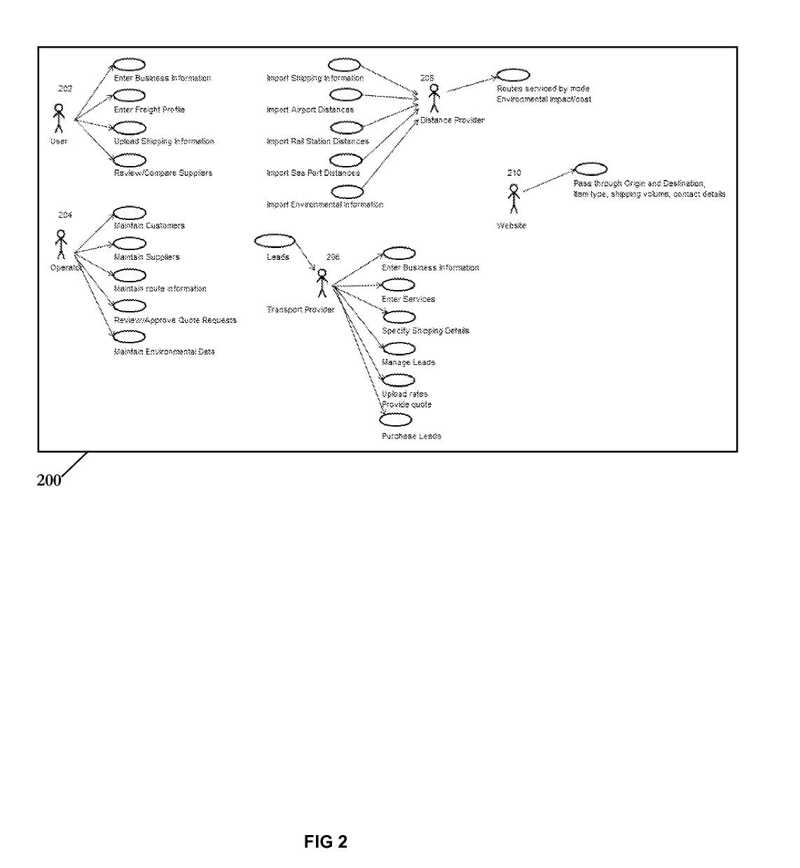

A functional overview of the system is depicted in FIG. 2. 202 shows the functional experience a person looking for logistics services (termed a ‘customer’) may expect on the website. The customer may be able to add information about their business, add information about their business requirements, enable them to enter their route information, enable them to upload their freight information via excel or data file and review or compare suppliers who meet their freight and business requirements. Following this the system collects the data from the spreadsheet and stores each item into corresponding fields in the database. 204 shows an entity or person known as the ‘operator’. The operator is responsible for reviewing customer details, both business and freight, review suppliers business information and customer requirements, maintain route information for the different modes, and maintain environmental data for calculation of environmental impact data. 206 shows an entity or person known as ‘transport provider’ or ‘supplier’. The supplier may be able to enter business profile information, the services they offer, their technical offerings, accreditations, and the like. The supplier may also purchase a lead and manage the leads they purchase. The supplier may also run various reports on customer leads that they have purchased. 208 shows an entity know as ‘distance provider’. The distance provider is responsible for identifying applicable modes of transport and suppliers that may service a customer's freight needs and calculating the environmental impact of each of these identified modal alternatives. A modal alternative refers to air, road, rail or sea freight transport. 210 shows an entity known as ‘website’. Website is a third-party website that is making use of a software plug-in that comprises components of the solution described herewith. Such a plug-in may be an application programming interfaces (API) facility that enables a site, for example Alibaba Group (http://www.alibaba.com), an internet-based businesses that includes business-to-business (B2B) international trade, online retail and payment platforms, and its users to get quotes for items they're thinking of purchasing. This is most advantageous to a B2B website as it closes the purchasing loop for customers who want to know how they'll get their goods if they purchase from a supplier on such a site. The website may pass through a request in the form of a file of information 520, containing—item type, applicable packaging type, shipping volume and customer details, customer address through to a search engine embodiment of the solution provided herewith. Customers may be automatically registered in 521 that are passed through via 520.

In 522 a portfolio named after the item and supplier details in 520 may be automatically created. A freight profile may be automatically updated for this customer in 524. A module may identify appropriate providers and routes 507 that may service the Customer's requirements, the rating engine 510B may also reference the credentials of the buyer from a site such as Alibaba as well as the customers information to rate the lead and buying intention of the prospective buyer. The supplier address details may be referenced where possible as the default origin location for any calculations. The customer may be automatically rated and a free sales lead 525 may be generated and sent to identified suppliers who meet the customer's requirements from 507.

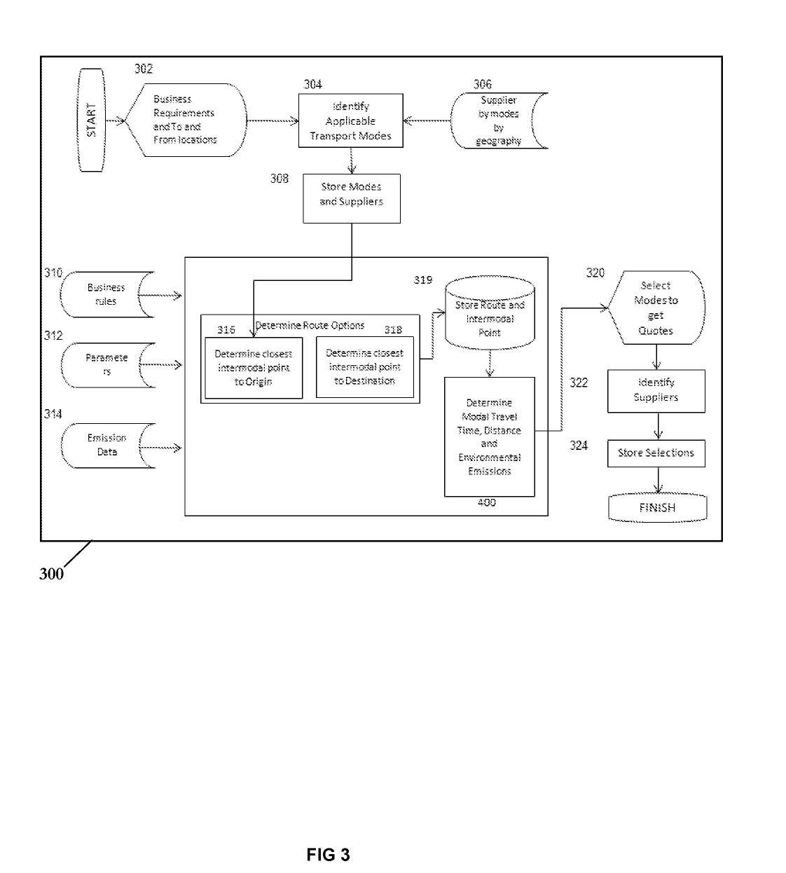

FIG. 3 is a flow chart describing a preferred import of files 102 and tables into a system 300 according to the invention. FIG. 3 describes what tables and files are imported from different sources, and how these are used with the customers business requirements to determine the modes of transport and suppliers that may service their needs. The different import files and import tables are used to provide modal alternatives for shipping the customer's freight from a point of origin to a destination.

The calculation of the modal alternatives is depicted in 316 and 318. Along with calculating the environmental impact it's desirable to calculate the overall transit time of transporting the freight from its origin to its destination 400. It should be noted that a modal alternative may only be presented to the user when a supplier may be identified from the applicable modal table as been able to provide that specific service according to the users' requirements 320.

The method for arriving at the modal alternatives may be described as follows—
1. Set up parameters 310 for the modes that indicate if we should calculate alternatives for that mode. i.e. if origin and destination locations are in same state, do not calculate alternate options for sea, rail and air modes. Alternatively, if road travel time is less than 11 hours 310 do not calculate other modal alternatives.
2. Provide a parameter for additional days for each mode which the operator may maintain 312. This number may be added to the transit time for the rail, sea or air legs of the trip. This parameter may be referenced when performing searches for modal alternatives for rail, air and sea modes.
3. Identify to and from locations from the customer requirements 302 for each route and search supplier by mode 304 to see if that geographic location is serviced. For each mode identify if at least one carrier servicing that state 306. Refer to table which contains mode by state may list any carrier that provides a service to that state.
4. If no alternate modes exist other than road, return stating that only road service is offered 304. Calculate route distance and time using a map plug-in API such as Google™ Maps API. The results are then stored as the modal option details for Road. Calculate environmental impact using data from 314.
5. Otherwise if other modes and suppliers are identified in the modal tables 308 calculate each alternative as follows:

To determine route option 1 for each mode we need to do the following:
a. Identify what suppliers operate in the geographic location 304
b. Identify the line(s)/flight paths/shipping lanes that travel to the same state as the destination 306
c. Determine what is the closest intermodal point for each mode of transport. Given the origin shipping point on a map, use reverse geocoding to find the closest intermodal point to the origin shipping point that exists on the line(s)/flight paths/shipping lanes (in 306) 316. Store the line and the station 319.
d. Determine what is the closest station to the destination shipping point on the same the line(s)/flight paths/shipping lanes as the closest line(s)/flight paths/shipping lanes to point A. Use reverse geocoding again to search the geocodes on the line(s)/flight paths/shipping lanes identified above 318. Store the line(s)/flight paths/shipping lanes 319.
   1. Determine the travel time and environmental impact between the closest the line(s)/flight paths/shipping lanes. Add this up from the table above 400.
   2. Determine what is the road travel time and environmental impact to the closest line(s)/flight paths/shipping lanes from table 400.
   3. Add the train/ship/plane travel time, road travel time, intermodal time and environmental impact to arrive at the total travel time and environmental impact for this mode/lane 400.

To determine route option 2 for each mode we need to do the following:
a. Given location B on a map, use reverse geocoding to find the closest station to the destination shipping point that exists on the line(s)/flight paths/shipping lanes in the table above 318. Store the line(s)/flight paths/shipping lanes and the intermodal point 319.
b. Determine what is the closest intermodal point to point A on the same line(s)/flight paths/shipping lanes as the closest intermodal point to the destination shipping point 319. Use reverse geocoding again to search the geocodes on the line(s)/flight paths/shipping lanes identified above. Store the intermodal point 319.
   1. Determine the travel time and environmental impact between the closest intermodal points. Add this up from the table above 400.
   2. Determine what is the road travel time and environmental impact to the closest intermodal points 400.
   3. Add the train/ship/plane travel time, road travel time, environmental impact and intermodal time to arrive at the total travel time for this mode/lane 400.
c. Determine the closest two options, and store the carriers that provide these services along with the details for each leg—road, rail, intermodal 400.
3. The user may then be presented on the screen with modal options 320 as identified in 400 so they may select which modal options they want quotes for.
4. Once the user has selected their modal options that they want quotes for they may press OK when done, the system may identify all relevant suppliers in the different modal options 322 so these suppliers may be sent their relevant leads.
5. Their selections may then be saved 322.

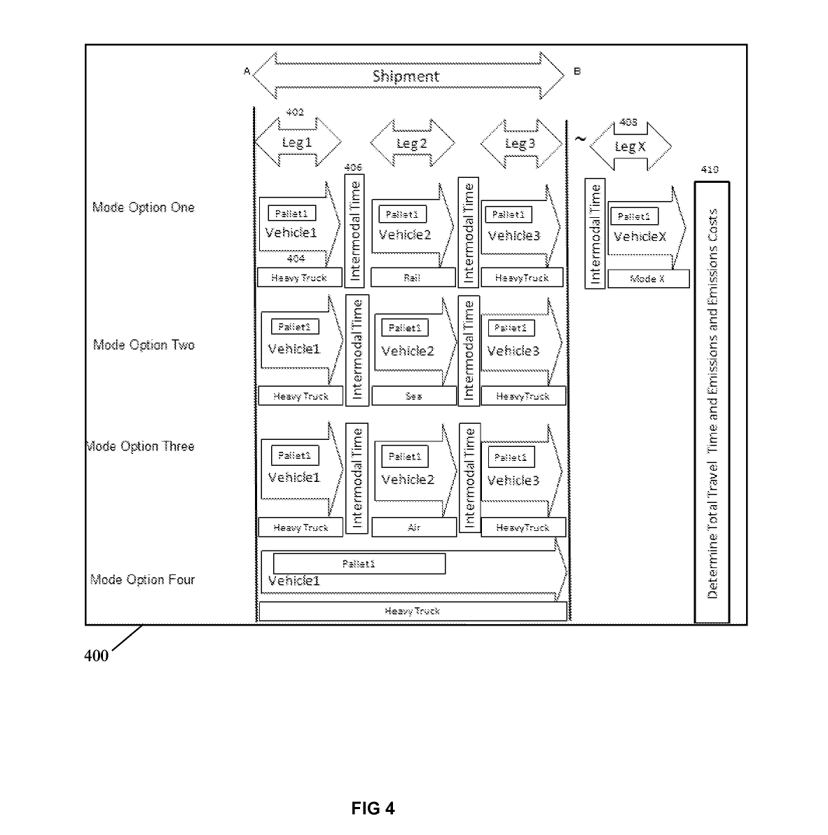

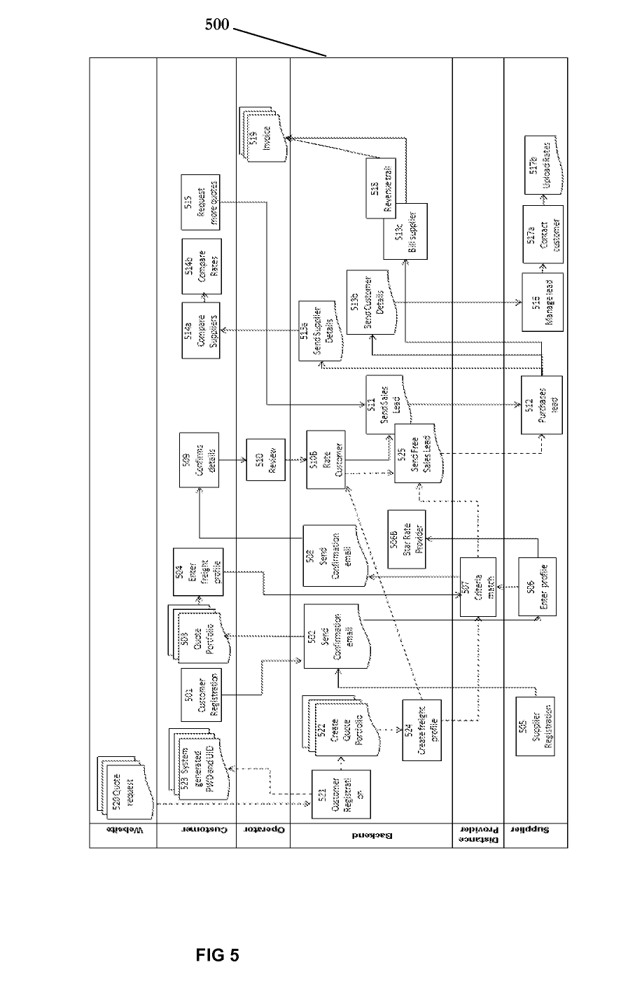

FIG. 4 provides a generic example 400 of typical legs of different shipments. The transport is divided into a number of different legs according to the different transport modes used on the way from its origin to its destination. FIG. 4 identifies the how different routes are analysed and modal options provided. Various legs are proposed to move freight using different modal options. Primarily road is used to move freight from an origin point to an intermodal point and from an intermodal point to a destination. The business rules 310 and supplier by mode by geography 306 data are used to determine if a modal alternative should be selected. i.e. if the road travel time is less than 12 hours or total kilometres travelled is less than 850 klms do not identify a modal alternative. The reason been is that it would not be economical or timely to use an intermodal service where the total road travel time is less than 12 hours or 850 klms. The supplier by mode by geography data is used to determine if a supplier even provides a modal service in the origin and destination states, if not, a modal option may not be provided.

FIG. 4. is directed to a situation where a shipment which has a shipping origin point A and a destination shipping point B. For each modal alternative calculated we need to identify the modes/vehicles 404 for each leg 402. For each leg 402 there may be an origin and a destination. The distance between the origin and destination for road legs may be calculated using a mapping API such as that provided by Google™ Maps. For distance and time calculation for modes of rail, sea or air these may be stored in a table for lookup either stored in the database or provided by a third party provider. It should be noted that there is no limit to the number of legs required in this process as expressed by 408. Once all the legs are determined and all the modes, distance and time are calculated for each leg the total travel time including intermodal time 406, environmental impact and cost is determined 410.

Taking into account the above outlined factors and the division of the shipments into different legs the carbon emissions related to each shipment may be calculated according to the following general principle:
1. Calculate the distance for each leg
2. Calculate the weight of each shipment
3. Calculate the total emissions of the vehicle for each mode
4. Add any emissions generated for intermodal movements
5. Add the emissions from the different legs of the shipment plus intermodal movements

As well as calculating alternate modes of transport, the system may also calculate CO₂ usage and cost for each mode based on the following calculation—

Carbon emissions of shipment per leg=Total Freight Tonnes*Distance*Emission Factor for Vehicle
Total Freight Tonnes is provided by the user.
Distance is calculated by the mapping application or the modal tables with specified routes between fixed infrastructure such as rail terminals, airports, harbour ports, and the like.
Cost for emissions from each mode are calculated as such—

(Total Freight Tonnes*Distance*Emission Factor for Vehicle)*(cost per tonne)

Some exemplary emission factors are listed below—

Emmission Factors: Freight Transport

| | EF (t CO₂/tonne km) |
|---|---|
| Land-based | |
| Light commercial vehicle | 1.80E−03 |
| Medium weight rigid truck | 1.78E−04 |
| Heavy articulated vehicle | 1.15E−04 |
| Rail (diesel locomotive) | 2.65E−05 |
| Shipping | |
| LNG tanker | 3.96E−05 |
| Bulk dry | 4.53E−06 |
| Container | 1.45E−05 |
| Refrigerated cargo | 7.41E−05 |
| RoRo cargo (small) | 5.66E−05 |
| RoRo cargo (large) | 2.00E−05 |
| Air freight | |
| Short haul flight (<500 km) | 5.70E−04 |
| Long haul flight (>500 km) | 1.58E−03 |

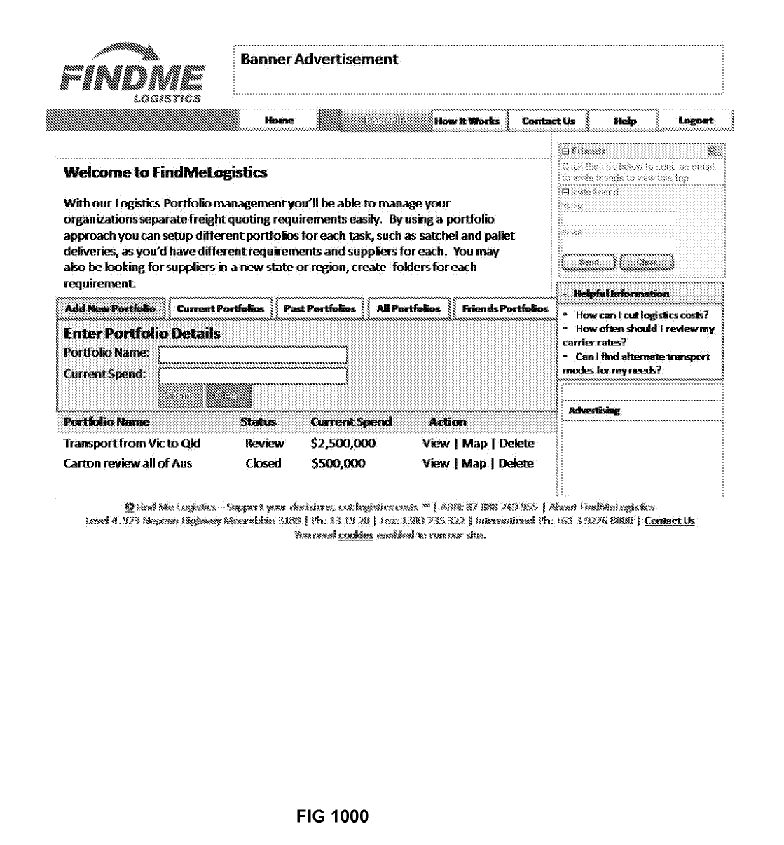

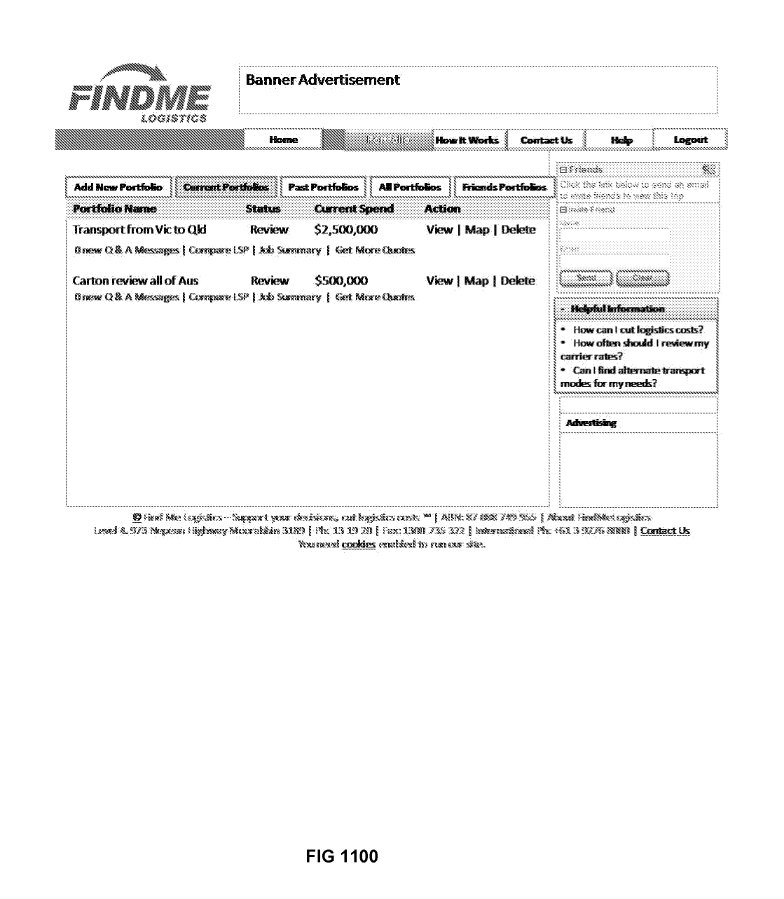

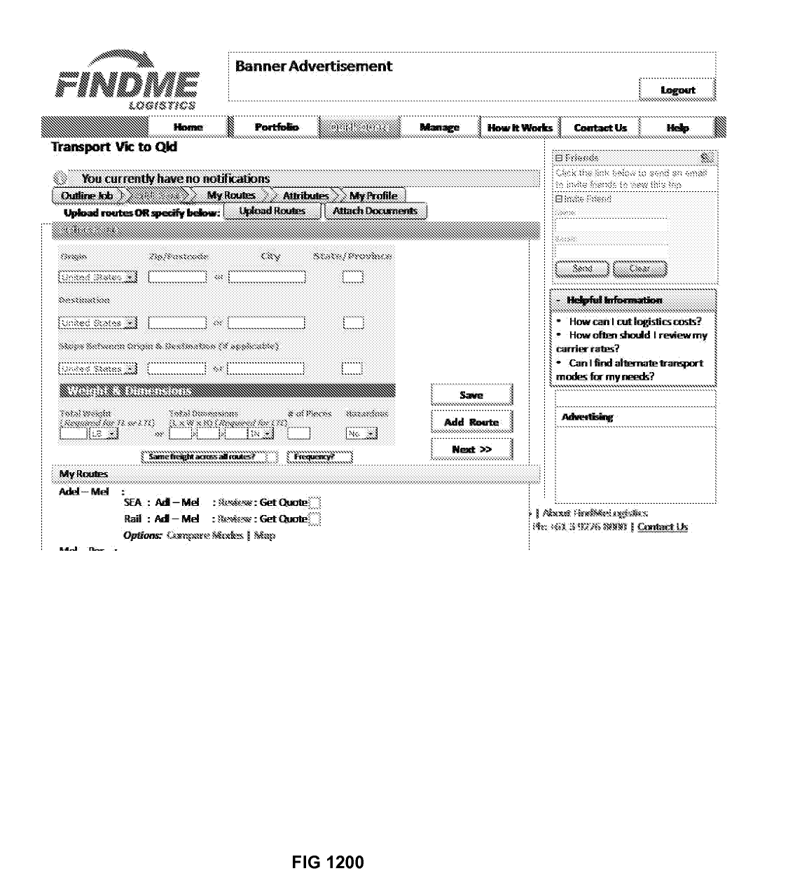

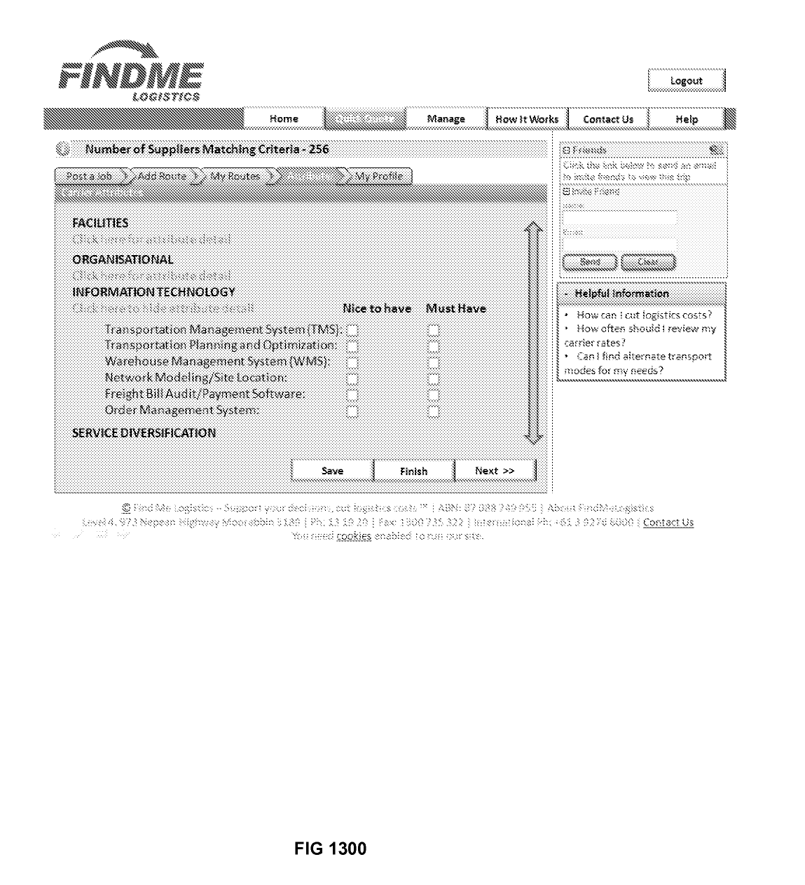

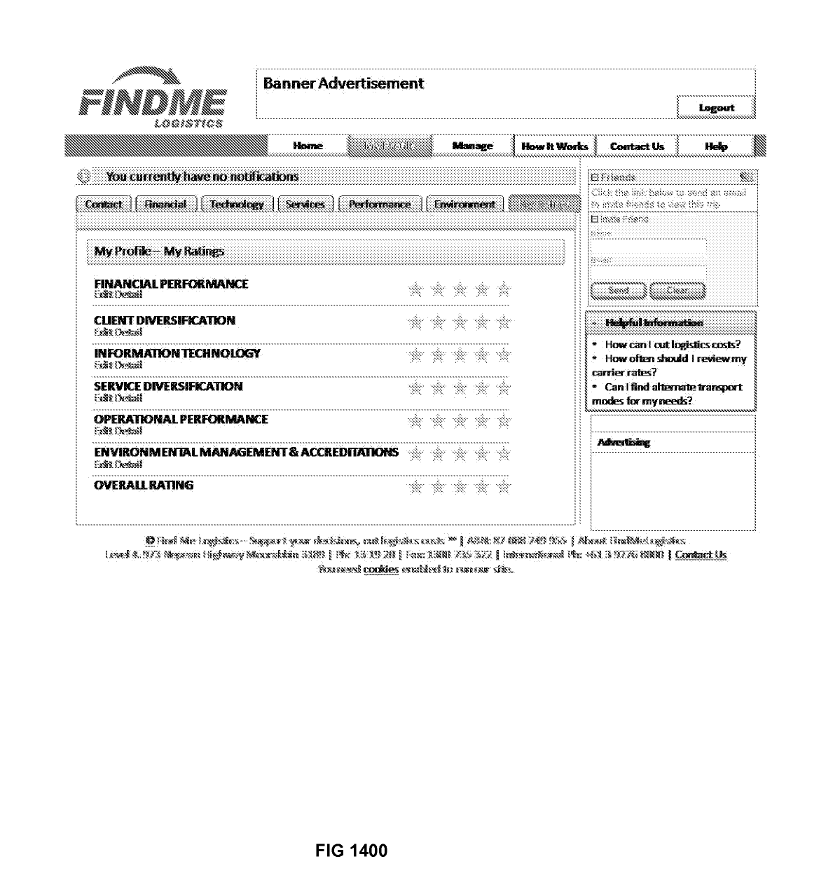

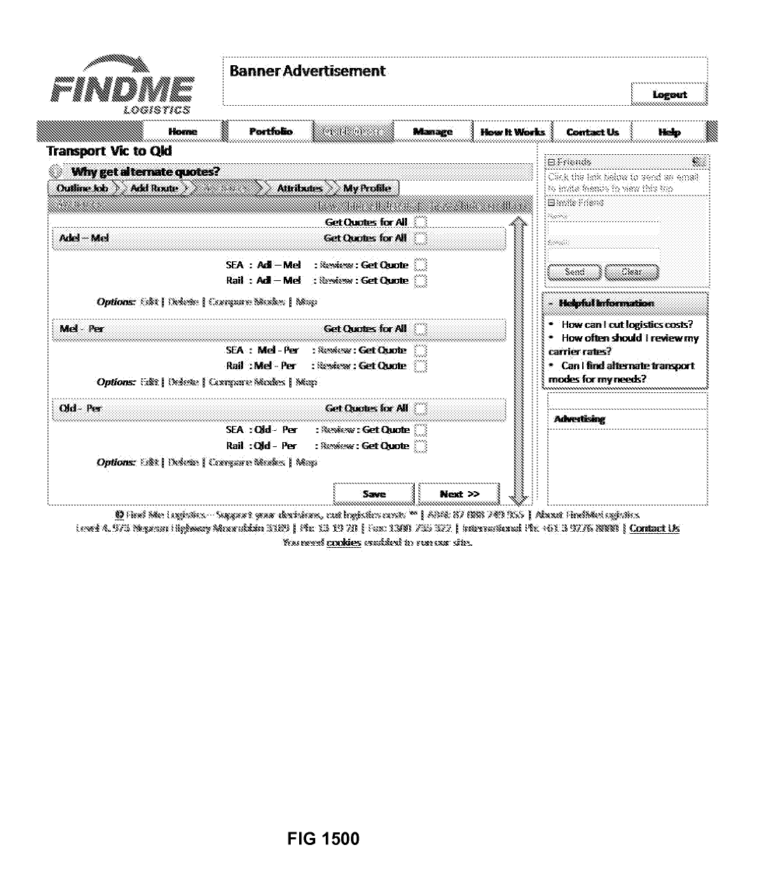

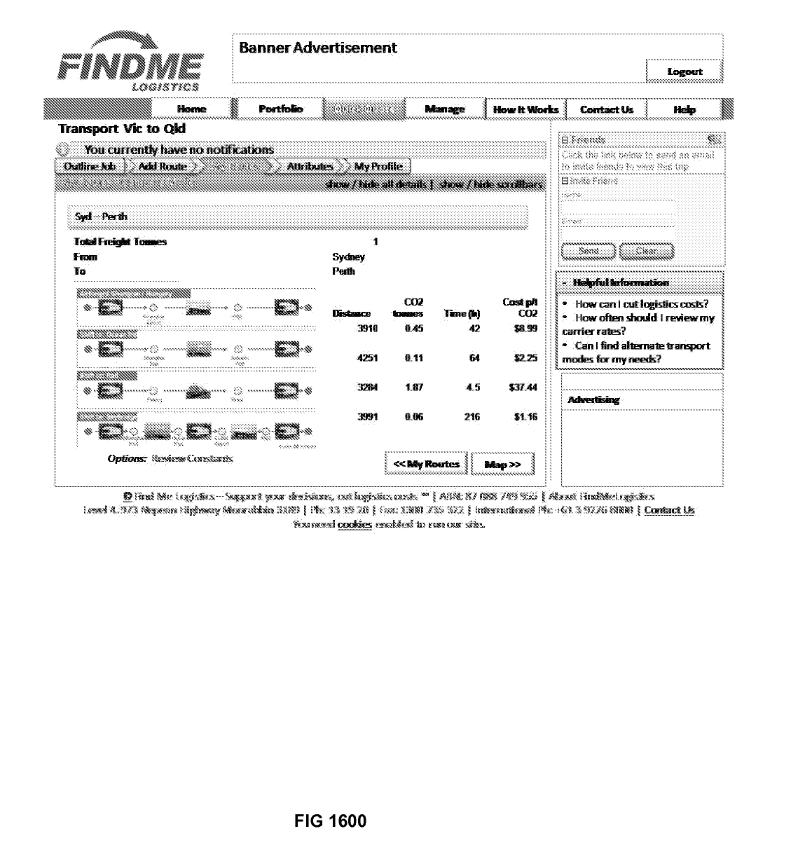

FIG. 5 describes another flow chart of the core operation process which is divided into six parts to demonstrate the movement of information and process flow between customers, suppliers and the core system in the identification of different modes of transport that may move freight from an origin to a destination location, and the environmental impact of each modal alternative. The customer registers 501 their business details which are then reviewed by the operator for completeness 501b and a confirmation email is sent back 502 with login details. The customer may then enter their Quote Portfolios 503 and FIG. 1000 which is a new folio requirement for their organisations freight transport needs. Once portfolios are created they may be deleted, edited or saved for later use FIG. 1100.

The customer then enters specific requirements for this portfolio 504. The requirements the customer may enter include route or shipping information containing the origin and destinations they are shipping to, the quantity and freight information for each route and the type of bid event; i.e. is it a blind or reverse auction. With a blind auction, suppliers do not have any visibility of their competitors bids per lane or their service offering. With a reverse auction the auction may begin with each prospective vendor issuing its starting price associated with its proposal. During a second round of bids, each vendor may have heard or may have seen via its computing system the bids proposed by each other vendor. Each vendor may then lower its price with one of the previously negotiated downward bidding increments in order to arrive at a lower price than its competitive vendors. This process may then continue until a lowest price is obtained through the bidding process.

At step 514b, the purchaser obtains the lowest bid from one of the prospective vendors and that vendor's proposal is accepted. Because the final contracts were previously executed by each prospective vendor, acceptance of the lowest bid by the purchaser, at step 514b, ends the process and that vendor's contract is accepted as the final contract for delivering the required services, or systems. FIG. 1200, and other business requirements such as technology offerings, service offerings, freight type, payment terms, environmental accreditations, organisational accreditations, operational performance etc FIG. 1300. It is also advantageous in some embodiments to provide an upload facility for customers to upload route information including origin and destination, freight type, quantity shipped and weight via CSV or MS Excel. The use of website form fields to receive the sets of logistics information is supplemented with an inbuilt spread sheet uploading facility. The system includes supplier spreadsheet templates that are preset with all the fields required. The spreadsheet templates may be downloaded to enable the supplier to create a spreadsheet and enter each item many times and once the spreadsheet is ready to upload the supplier may log into the website and choose to upload the spreadsheet. Following this the system collects the data from the spreadsheet and stores each item into corresponding fields in the database

As each attribute is selected a count of the number of carriers servicing those lanes and having those attributes is updated and displayed.

The supplier at the same time registers 505 and submits their details to the operator to review. The operator may then confirm the registration details of the supplier and send a confirmation email to the supplier with login details 502. The supplier may then identify the attributes of their ideal customer.

Once registered the supplier may then enter profile information 506 such as technology offerings, service offerings, freight handled, payment terms, environmental accreditations, organisational accreditations, operational performance, and the like. It should be appreciated that this system is not limited to these categories, others may be added at any stage. Once all attributes are entered the system may then score the aforementioned areas FIG. 1400 according to the following scoring methodology 506b.

### Financial Performance Calculation

The following is the scoring calculation for Financial Performance. The Z-score is a linear combination of four or five common business ratios, weighted by coefficients. The Z Score is calculated by multiplying each of several financial ratios by an appropriate coefficient and then summing the results. The ratios rely on these financial measures:
Working Capital is equal to Current Assets minus Current Liabilities.
Total Assets is the total of the Assets section of the Balance Sheet.
Retained Earnings is found in the Equity section of the Balance Sheet.
EBIT (Earnings Before Interest and Taxes) includes the income or loss from operations and from any unusual or extraordinary items but not the tax effects of these items. It may be calculated as follows: Find Net Income; add back any income tax expenses and subtract any income tax benefits; then add back any interest expenses.
Market Value of Equity is the total value of all shares of common and preferred stock. The dates these values are chosen need not correspond exactly with the dates of the financial statements to which the market value is compared.
Net Worth is also known as Shareholders' Equity or, simply, Equity. It is equal to Total Assets minus Total Liabilities.
Book Value of Total Liabilities is the sum of all current and long-term liabilities from the Balance Sheet.
Sales includes other income normally categorized as revenues in the firm's Income Statement.

Use balance sheet figures from the end of the reporting period for all Z Score calculations.

The following table shows how these measures are used to calculate the three versions of the Z Score. The table is explained below.

### The Z Score Versions

| | Z | Z1 | Z2 | Mean Ratio Values | |
|---|---|---|---|---|---|
| | Public | Private | General | | Not |
| Variable | Mfg | Mfg | Use | Bnkrpt | Bnkrpt |
| $X 1 = \frac{Working Capital}{Total Assets}$ | 1.200 | 0.717 | 6.560 | (0.061) | 0.414 |
| $X 2 = \frac{Retained Earnings}{Total Assets}$ | 1.400 | 0.847 | 3.260 | (0.628) | 0.355 |
| $X 3 = \frac{EBIT}{Total Assets}$ | 3.300 | 3.107 | 6.720 | (0.318) | 0.154 |
| $X 4 = \frac{Mkt Value of Equity}{Total Liabilities}$ | 0.600 | | | 0.401 | 2.477 |
| $X 4 A = \frac{Net Worth}{Total Liabilities}$ | | 0.420 | 1.050 | 0.494 | 2.684 |
| $X 5 = \frac{Sales}{Total Assets}$ | 1.000 | 0.998 | | 1.603 | 1.939 |
| Cutoff Values | | | | | |
| Safe if greater than: | 2.99 | 2.90 | 2.60 | | |
| Bankrupt if less than: | 1.81 | 1.23 | 1.10 | | |
| Mean Scores | | | | | |
| Nonbankrupt | 5.02 | 4.14 | 7.70 | | |
| Bankrupt | (0.29) | 0.15 | (4.06) | | |

In other words, the three Z Score versions (described below) are calculated as follows:

Z=1.2*X1+1.4*X2+3.3*X3+0.6*X4+X5

Z1=0.717*X1+0.847*X2+3.107*X3+0.42*X4A+0.998*X5

Z2=6.56*X1+3.26*X2+6.72*X3+1.05*X4A

It is proposed that by using the z-score calculation for Z2 (General Use) above and using the scoring method below, customers may be able to view the financial stability of a supplier more easily and better help them in making their purchasing decision.

The 5-star rating for Z score is calculated above and scored as follows—
0-1.8=1 star
1.8-2.7=2 stars
2.7-2.99=3 stars
3-3.99=4 stars
4 and above=5 stars

It should be noted that this model may change at any time and the design of the model may be flexible enough to allow for these changes.

### Client Diversification Methodology

The following is the scoring calculation for client diversification. There are a number of possible areas that may be scored. It should be noted that this model may change at any time and the design of the model may be flexible enough to allow for these changes.
1-5 industries=1 star
6-10 industries=2 stars
11-15 industries=3 stars
16-20 industries=4 stars
21>=5 stars

### Information Technology

The following is the scoring calculation for Information Technology where each line or variable in the table below may have a different weighting or point score attributed to it. When it comes to scoring a supplier it may be noted what variables or requirements they meet below and then total these up giving a score out of 100. The five star rating may then be calculated as follows—

### Scoring

Score of 0-19=1 star
Score of 20-39=2 stars
Score of 40-59=3 stars
Score of 60-79=4 stars
Score of 80-100=5 star

There are a number of possible areas that may be scored. It should be noted that this model may change at any time and the design of the model may be flexible enough to allow for these changes.

Information Systems

| | SCORING |
|---|---|
| Software Type | |
| Transportation Management System (TMS): | 10 |
| Transportation Planning and Optimization: | 10 |
| Warehouse Management System (WMS): | 10 |
| Network Modeling/Site Location: | 5 |
| Freight Bill Audit/Payment Software: | 5 |
| Order Management System: | 5 |
| TMS Optimization Routines: | |
| End-to-end Matching/Continuous Moves | |
| Mode Conversion/Optimization | |
| Many to Many Supply Network Optimization | |
| Other Systems Capabilities: | |
| Bar Coding | 10 |
| Demand & Supply Forecasting | 5 |
| EDI Handling | 10 |
| ERP Interfaces Internet Customer Access | 10 |
| Integrated TMS & WMS | 5 |
| Real-time Track & Trace | 10 |
| Radio Frequency Devices XML Data Handling | 5 |

Overall Information Systems Rating: G (E = Excellent, G = Good, C = Capable/Adequate, and I = Inadequate)
Founding Business: Broker N = Non Asset Based)
Overall Capability of Provider: Excellent transportation and special projects manager.

### Service Diversification

The following is the scoring calculation for client diversification where each line or variable in the table below may have a different weighting or point score attributed to it. When it comes to scoring a supplier it may be noted what variables or requirements they meet below and then total these up giving a score out of 100. The five star rating may then be calculated as follows—

### Scoring

Score of 0-19=1 star
Score of 20-39=2 stars
Score of 40-59=3 stars
Score of 60-79=4 stars
Score of 80-100=5 star

There are a number of possible areas that may be scored. It should be noted that this model may change at any time and the design of the model may be flexible enough to allow for these changes.

| | |
|---|---|
| TRANSPORTATION MANAGEMENT SERVICES | 45 |
| Transportation Planning | 10 |
| End-to-end Load Matching | |
| Carrier Mgmt and Contracting | |
| Inbound Shipment Planning | |
| Outbound Shipment Planning | |
| Mode Conversion/Optimization | |
| Transportation Execution | 10 |
| Exception Handling | |
| Contract File Maintenance | |
| Load Tendering | |
| Tracking & Tracing | 5 |
| Performed In-house | |
| Outsourced | |
| Transportation Services | 25 |
| Air | |
| Brokerage Operations | |
| Dedicated Contract Carriage | |
| Freight Forwarding | |
| Less than Truckload (L.T.L.) | |
| Just-In-Time (J.I.T.) | |
| Ocean Shipping | |
| Small Package | |
| Specialized | |
| Rail | |
| Rail TOFC/COFC | |
| Truckload | |
| Pre-Audit | |
| Post-Audit | |
| Freight Bill Payment: | |
| Home Delivery | |
| Loss/Damage Claims | |
| Package Delivery | |
| WAREHOUSE & VALUE = ADDED SERVICES | 15 |
| Warehouse/Distribution Centre | 10 |
| Facilities Mgmt | |
| Frozen | |
| Refrigerated | |
| Rail Siding | |
| Value-Added Services | 5 |
| Sequencing/Metering | |
| KanBan | |
| Sub Assembly | |
| Manufacturing Support | |
| Customization | |
| Cross Docking Pool Distribution | |
| Merge in Transit | |
| Call Centres | |
| Kitting | |
| Pick/Pack | |
| Labelling | |
| Specialty Packaging | |
| Reverse Logistics | |
| Returnable Container Mgmt | |
| Repair/Refurbish | |
| Inventory Control/Vendor Mgmt | |
| Lot Control | |
| Store Support/Direct Store Delivery | |
| OTHER 3PL SERVICES, SKILLS & HANDLING | 25 |
| Other 3PL Services | |
| Factoring/Financial Services | |
| Purchase Order Mgmt Quality Control | |
| Order Mgmt Project Logistics Union Services | |
| Installation/Removal | |
| Consulting/Process Reengineering | |
| Special Skills & Material Handling | |
| Hazardous Materials Temperature Controlled | |
| Bulk Commodities Food Grade/Sterile | |
| ISO Certified Certification | |
| INTERNATIONAL SERVICES & PRIMARY AREAS SERVED | 15 |
| International Services | |
| Customs Brokerage | |
| Foreign Trade Zone | |
| NVOCC | |
| Export Crating Port Services | |
| Consolidation | |
| North America | |
| Areas Served | |
| Europe | |
| Asia/Pacific Latin America | |
| Australia/New Zealand | |
| Africa/Middle East | |

### Operation Performance

The following is the scoring calculation for client diversification where each line or variable in the table below may have a different weighting or point score attributed to it. When it comes to scoring a supplier it may be noted what variables or requirements they meet below and then total these up giving a score out of 100. The five star rating may then be calculated as follows—

### Scoring

Score of 0-19=1 star
Score of 20-39=2 stars
Score of 40-59=3 stars
Score of 60-79=4 stars
Score of 80-100=5 stars

There are a number of possible areas that may be scored. It should be noted that this model may change at any time and the design of the model may be flexible enough to allow for these changes.

| Reporting | SCORING |
|---|---|
| DIFOT | 20 |
| Transit time | 20 |
| Number of consignments on time | 20 |
| Number of consignments delivered late | 20 |
| Number of consignments damaged | 10 |
| Number of consignments lost | 10 |

Freight volumes - Chep pallets and freight spaces (indicator of vehicle utilisation)
Freight volume versus available fleet capacity (calculate fleet utilization)
Number of consignments moved in a given time period
Transport cost per customer selling unit

### Environmental Management

The following is the scoring calculation for client diversification where each line or variable in the table below may have a different weighting or point score attributed to it. When it comes to scoring a supplier it may be noted what variables or requirements they meet below and then total these up giving a score out of 100. The five star rating may then be calculated as follows—

### Scoring

Score of 0-19=1 star
Score of 20-39=2 stars
Score of 40-59=3 stars
Score of 60-79=4 stars
Score of 80-100=5 stars

There are a number of possible areas that may be scored. It should be noted that this model may change at any time and the design of the model may be flexible enough to allow for these changes.

| | SCORING |
|---|---|
| ISO 14000 family | 15 |
| Carbon neutral | 5 |
| carbon negative | 5 |
| Environmentally friendly packaging? | 5 |
| alternative fuel vehicle technology, solar panels and | 5 |
| reforestation projects | |
| Alternative energy powers site | 5 |
| Use of double decker vehicles | 5 |
| SMART heavy vehicle | 10 |
| aerodynamically profiled articulated trailers | 5 |
| electric vans both in the sub 3.5 tonne and 9 tonne categories | |
| Re-usable packaging | 5 |
| Green Methodologies Used | |
| LEAN | 10 |
| Six Sigma | 10 |
| Reverse Logistics | 15 |

### Accreditations

The following is the scoring calculation for client diversification where each line or variable in the table below may have a different weighting or point score attributed to it. When it comes to scoring a supplier it may be noted what variables or requirements they meet below and then total these up giving a score out of 100. The five star rating may then be calculated as follows—

### Scoring

Score of 0-19=1 star
Score of 20-39=2 stars
Score of 40-59=3 stars
Score of 60-79=4 stars
Score of 80-100=5 stars

There are a number of possible areas that may be scored. It should be noted that this model may change at any time and the design of the model may be flexible enough to allow for these changes.

| | SCORING |
|---|---|
| National Heavy Vehicle Accreditation Scheme (NHVAS). | 10 |
| NLSC accredited in following areas - | |
| 1. Legal Compliance and CoR | 10 |
| 2. OH&S Risk Assessment & Compliance | 10 |
| 3. Fatigue Management | 10 |
| 4. Communication | 5 |
| 5. Safe Load | 10 |
| 6. Speed Management | 10 |
| 7. Equipment | 5 |
| 8. Driver Health/Drug & Alcohol free workplace | 10 |
| 9. Subcontractor Assessment | 10 |
| 10. Operational Infrastructure | 5 |
| RLSC signatory | 5 |

It should be noted that the scoring model may be changed, with the additional or removal of comparison criteria and categories.

The system, once it has supplier data in the system, may then perform a match 507 comparing customer requirements 504 with supplier profiles 506 to identify different modes of transport that may service the customer or that meet the customer's requirements, the system also calculates the environmental impact and shipping time for each modal alternative FIG. 1600. These modal alternatives are displayed for the customer so they may choose which modal alternatives they'd like quotes for FIG. 1500. A map interface is also provided to enable customers to view proposed routes FIG. 1700. Once the customer selects the options they'd like quotes for they are sent a confirmation email 508.

The confirmation email contains all the customer requirements including the modal selections they made for each route. The customer needs to confirm the details provided before they may be sent to any suppliers 509.

The operator then reviews the confirmed customer details and ensures there are no gaps in the customer's request, if there are any gaps the operator may follow up with the customer 510. Prior to been sent to suppliers the customer is rated 510b and their intention to buy is calculated. The intention to buy may prove most advantageous to suppliers as they have a good indication of the customers willingness to buy. The customer request may then be tagged as a sales lead 511 and sent to all suppliers who meet the customer's requirement as identified in 507.

The sales lead 511 contains all the information about the customer business requirements—route details, technology, service, freight handled, payment terms, environmental accreditations, organisational accreditations, operational performance requirements, current transport spend, expected transport spend, and the like. Everything may be sent other than the name of the customer and their contact details.

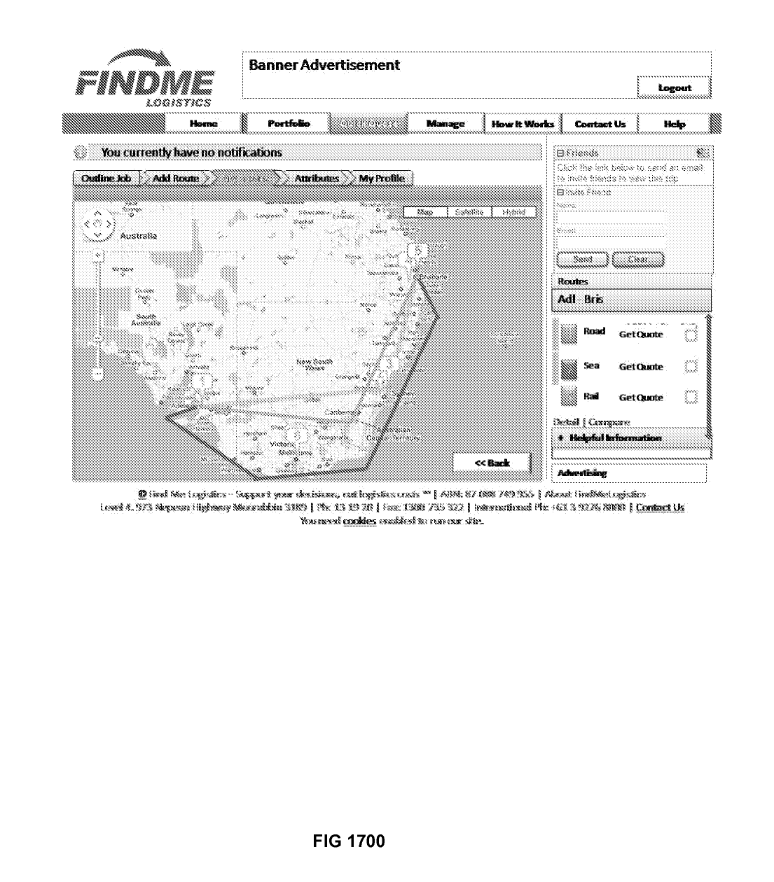

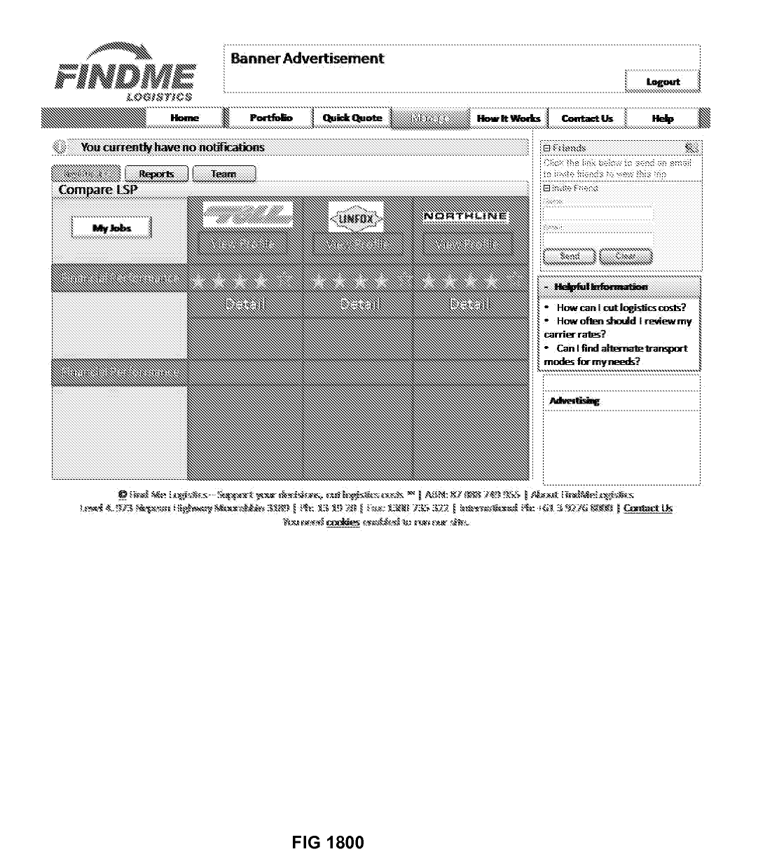

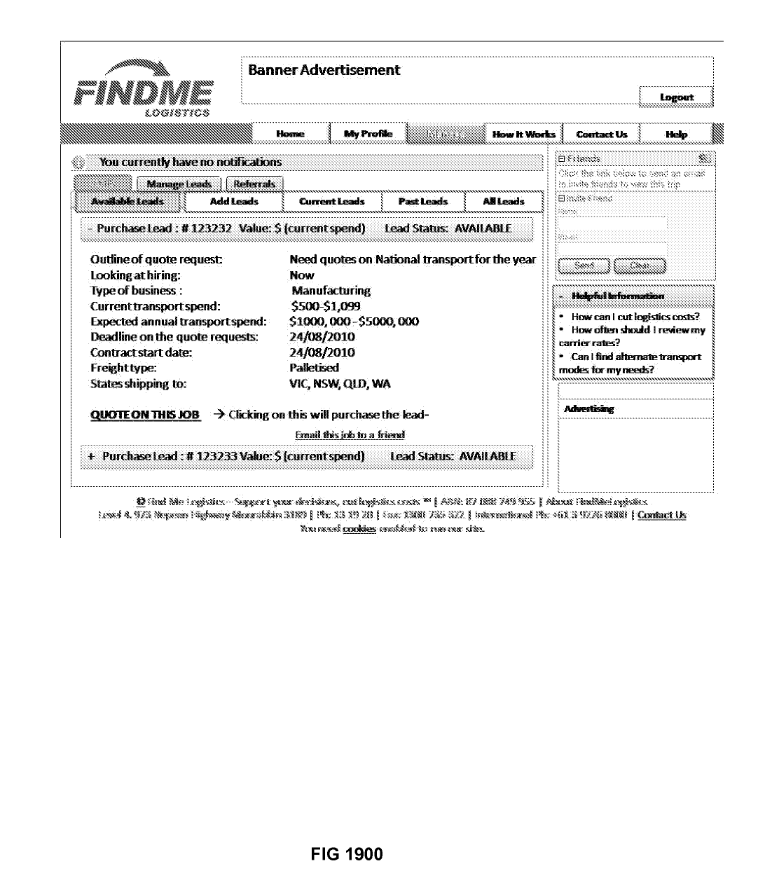

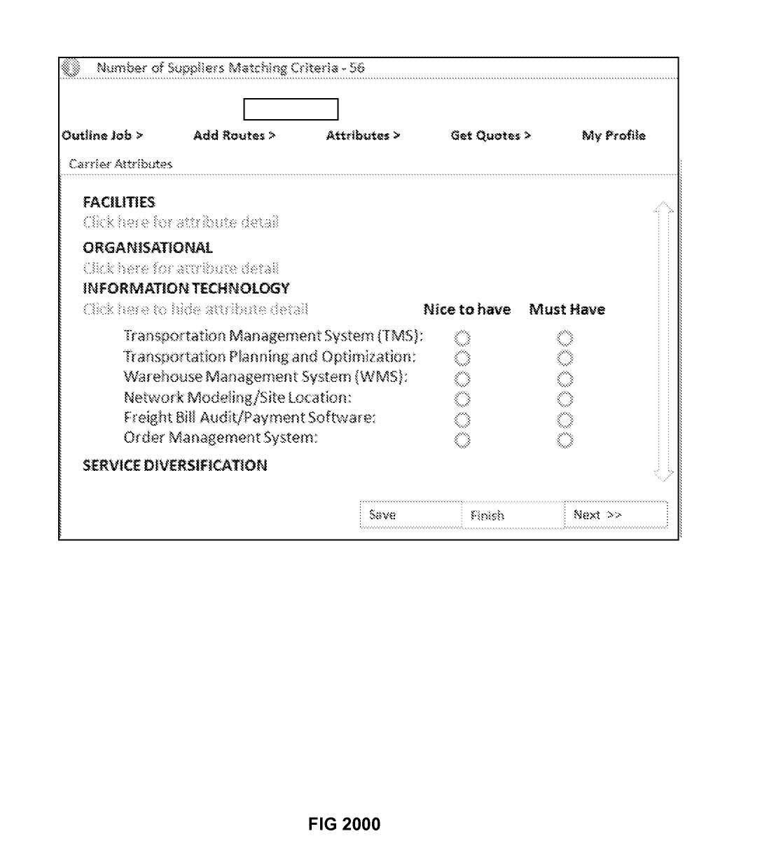

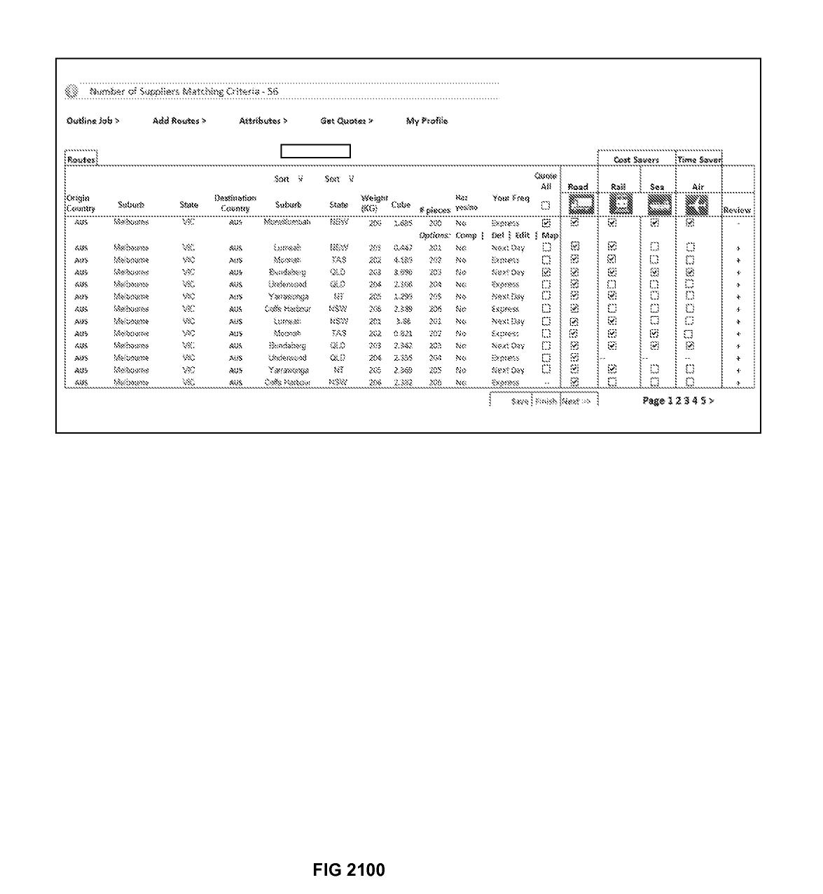

Suppliers who meet the requirements may then choose to purchase the lead by following the link in the email and purchasing the lead on the website 512 and FIG. 1900.

The system may then send the customer the supplier's details 513a so the customer may review and compare the supplier to other suppliers who've purchased the sales lead 512 and FIG. 1800.

At the same time the customer's details are sent to the supplier 513b so the supplier may allocate the lead to someone for follow-up 516.

The supplier is also billed for the value of the lead 513c as per the current subscription package. If the supplier chooses the trailing income commission option 518 in their subscription, the revenue trail may start from the time the lead is purchased. If the supplier is successful in winning the customer's business they may be invoiced 519 at a pre-determined time(s) in the future for a percentage of the annual revenue the customer generates for the supplier.

The supplier may then contact the customer with the details provided 517a and upload or enter any applicable quote rates 517b and business information via excel or data file. The use of website form fields to receive the sets of logistics information is supplemented with an inbuilt spread sheet uploading facility. The system includes supplier spreadsheet templates that are preset with all the fields required. The spreadsheet templates may be downloaded to enable the supplier create a spreadsheet and enter each item many times and once the spreadsheet is ready to upload the supplier may log into the website and choose to upload the spreadsheet. Following this the system collects the data from the spreadsheet and stores each item into corresponding fields in the database. The uploaded rates are then comparable 514b. The customer may then compare rates provided by suppliers of one mode such as road, to the rates and travel information, such as travel time and environmental impact, of another mode, such as rail intermodal. In this way the customer may identify savings in using an alternate mode of transport when reviewing their freight rates. This is enabled in the rate comparison screen by indicating under each route/lane if alternate modes are available, this may be in the form of a hyperlink or button, which when clicked may display the alternate modes underneath lane/routes displayed.

Customers may request additional quotes 515 if not satisfied with the suppliers who've responded or their rates. This re-quoting process may eliminate suppliers who have purchased the lead previously to eliminate any double purchase of the same lead.

520 shows the integration of the invention described from within another website via API or similar. Once the user has submitted a freight transport request from within the third party website the system may receive the customer's information, the item, item quantity, container description and other useful information. The customer may have an account automatically created for them 521 using the details sent through from 520 where a user ID and password 523 may be provided.

The system may then create a portfolio 522 using the information from 520 using the supplier, item and other relevant information to create a portfolio name which is meaningful. The system may then create a freight profile 524 with inputs from 520.

The system may then perform a criteria match 507 looking at the item and location information from 520 and identifying users and alternate modes of transport for shipping the goods from the supplier address details passed from 520 to the destination point provided in 520. At the same time the customer may be related 5108. A free sales lead with the information from 510b, 522 and 524 may be sent to the relevant suppliers where they may be purchased at zero cost. Having already submitted their details and the system identified providers for their request these users may be able to view supplier profiles immediately if suppliers have purchased their lead 512. These customers may at any time update and complete their profiles for future use 501 and 503. The process may continue from 512 as above for these customers.

In an embodiment the system 300 advantageously operates on a national and/or an international basis to provide the ability to source logistics services. The system 300 provides international search capabilities with comprehensive searching that enables members to search for logistics companies offering logistics services that matches desired criteria.

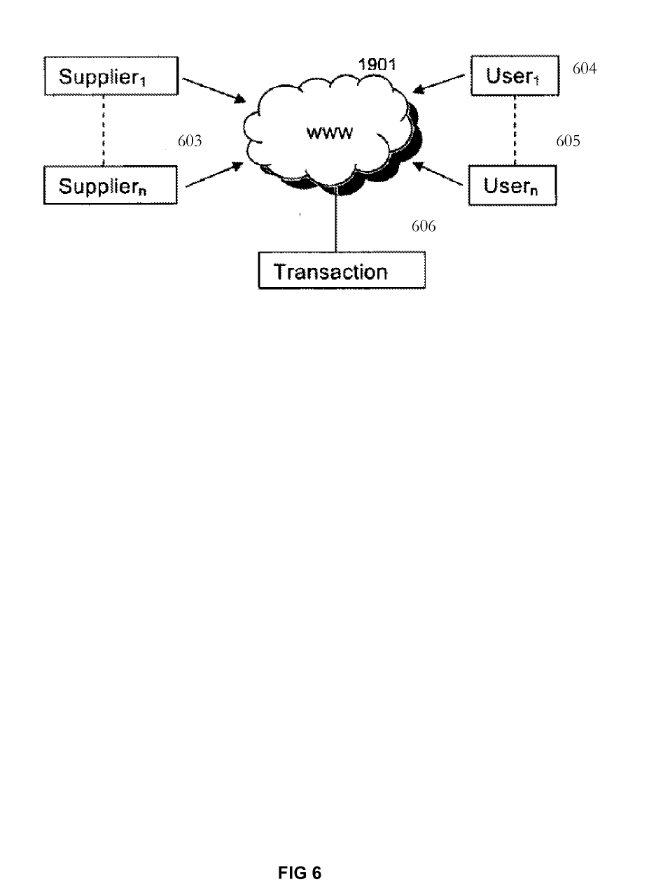

In FIG. 6, there is illustrated an embodiment of the present invention directed to providing logistics services sourcing on an international basis. A database and/or system according to the present invention is provided at 601. Preferably, the system is provided via a website and thus access via the Internet is convenient. Any number of suppliers (1 to n) and or providers 602, 603 of logistics information or logistics service providers may subscribe or provide the logistics information to the database 601. The suppliers may be based in any country, the same or different countries. Equally any number of customers (1 to n) 604, 605 may subscribe to the present invention, and seek logistics services in accordance with the various methods disclosed herein. When the customer has located a suitable logistics services provider a transaction 606 may occur.

The benefits this embodiment include, without limitation:
Global searching
Inter-country searching
Intra country searching
No real knowledge of logistics in other countries required by users to purchase logistics services in other countries
Offers ability for users to learn about logistics services in other countries
Suppliers may market across boarders
Convenience

In an embodiment the system advantageously gathers statistics and logs user activity for use in analysing trends. The forms of statistics gathered includes customer information, supplier information, logistics information, demographic information, sales/bids/conversions records, search data site traffic data, media publisher data ISP records, banking transaction records, advertising content, enquiry data and message centre records. With online advertisements including banner advertisements further statics gathered include how many people view it, how many click throughs and conversion statistics.

In this arrangement there is an associated database that is to be separated from or integrated with the actual portal server, containing the various statistical forms of information gathered including such as demographical information, ratings and various other information that may be obtained by a research group or software program which provides a user with statistics beneficial to a logistics company in identifying and monitoring target markets.

It is envisaged that means for providing statistical information may be adapted to record and evaluate and reproduce information provided on the website and actions conducted through the website. For example, it may be possible to determine which search terms and/or categories are most searched, the percentage of logistics services purchased and a plurality of other vital information and/or statistics which would be beneficial to logistics companies to indicate various existing or ongoing trends in the marketplace.

The results may then be reproduced in tabulated, plot, or any other suitable form which provides easy and quick access to relevant information. This information may preferably be on-sold to companies who wish to have access to this data for an additional cost. As such, the method and system for sourcing and managing logistics requirements may also be used as a valuable resource tool for individuals and/or businesses. It also provides an additional means of marketing for an individual and/or business to provide exposure to a wide demographic range. It is envisaged that the system may also provide online marketing tools which enable an individual and/or business to further utilise the system as a resource tool, with assistance in creating business and marketing plans.

The system provides means which enables a user to obtain various statistics that are beneficial to a freight logistics company. It is envisaged that the means for providing statistical information may be adapted to record and evaluate and reproduce information provided on the website and actions conducted through the website. For example, it may be possible to determine which search terms and/or categories are most searched, the percentage of logistics services purchased and a plurality of other vital information and/or statistics which would be beneficial to logistics companies to indicate various existing or ongoing trends in the marketplace. The results may be reproduced in tabulated, plot, or any other suitable form which provides easy and quick access to relevant information. It is envisaged that this information may be on-sold to companies who wish to have access to this data.

In a particularly advantageous feature, if certain logistics services are continually not selected they are published in a magazine to entice other members. This involves receiving different sets of logistics information associated with logistics criteria for logistics sourcing requirements and storing those sets. The sets of sets of logistics information are searched to locate at least one set that meets with business logistics criteria. After this particular sets of logistics information are highlighted when then said particular sets of logistics information repetitively do not meet business logistics criteria. This is performed by gathering related statistics as described above.

In this arrangement sets of logistics information are highlighted by providing an online publication directing readers to said particular sets and by providing an online newsletter and an e-magazine which contains the logistics requirements.

It is envisaged that the invention may also offer logistics services to both customers and suppliers on the website of the invention as a means for generating revenue for the provider. The provider may have provided account managers with restricted access such they are able to add/delete/modify accounts, assign contracts to sellers, manage banner advertising, control customer and supplier ratings and other specific duties as required.

1-20. (canceled)

21. A computer-based method for assisting a logistics decision of a potential customer, the method comprising the steps of:
receiving at least one logistics related requirement from the potential customer, calculating at least one suitable logistics option from a plurality of supplier-provided logistic options, and providing an output of at least one logistics option in a form readable by the potential customer.

22. The computer-based method of claim 21 wherein the at least one logistics-related requirement is selected from the group consisting of: a preferred or required origin point, a preferred or required destination point, a preferred or required mode of transport, a preferred or required travel time, a preferred or required delivery date, a preferred or required environmental impact caused by the logistic, a preferred or required cost, a preferred or required payment method or term, a preferred or required accreditation of a supplier, and a preferred or required level of operational performance of a supplier.

23. The computer-based method of claim 21 comprising the step of receiving a supplier-provided logistics option.

24. A computer-base method of claim 23 wherein the supplier-provided logistics option is associated with a logistics-related parameter selected from the group consisting of: geographical operational area, a mode of transport, a travel time, an environmental impact caused by the logistic, a cost, a payment method or term, an accreditation, and operational performance information.

25. The computer-based method of claim 21 wherein the output displays a logistics option for 2, 3, 4, 5, 6 or more modes of transport.

26. The computer-based method of claim 21 wherein the output displays a logistics option for 2, 3, 4, 5, 6 or more suppliers.

27. The computer-based method of claim 21 wherein the output displays a logistics-related parameter selected from the group consisting of: a geographical operational area, a mode of transport, a travel time, an environmental impact caused by the logistic, a cost, a payment method or term, an accreditation, and operational performance information.

28. The computer-based method of claim 21 wherein the customer readable form comprises a map displaying route options for two or more suppliers.

29. The computer-based method of claim 21 wherein the output is devoid of information allowing for identification of the supplier.

30. The computer-based method of claim 21 devoid of means for the potential customer to contact the supplier.

31. A computer-based method for matching a logistics supplier with a potential customer, the method comprising the steps of:
receiving information related to the services of the logistics supplier,
calculating at least one suitable potential customer option from a plurality of potential customer-provided logistics requirements, and
providing an output of at least one potential customer option in a form readable by the supplier.

32. The computer-based method of claim 31 wherein the information related to the services of the logistics supplier is associated with a logistics-related parameter selected from the group consisting of: geographical operational area, a mode of transport, a travel time, an environmental impact caused by the logistic, a cost, a payment method or term, an accreditation, and operational performance information.

33. The computer-based method of claim 31 comprising the step of receiving a customer-provided logistics requirement.

34. The computer-based method of claim 33 wherein the information related to the customer-provided logistics requirement is selected from the group consisting of: a preferred or required origin point, a preferred or required destination point, a preferred or required mode of transport, a preferred or required travel time, a preferred or required delivery date, a preferred or required environmental impact caused by the logistic, a preferred or required cost, a preferred or required payment method or term, a preferred or required accreditation of a supplier, and a preferred or required level of operational performance of a supplier.

35. The computer-based method of claim 31 wherein the output comprises information allowing the supplier to contact the potential customer.

36. The computer-based method of claim 31 wherein the output is information related to the potential customer selected from the group consisting of: a name, a physical address, an email address, and a telephone number.

37. The computer-based method of claim 31 comprising means for the potential customer to contact the supplier.

38. The computer-based method of claim 31 wherein the potential customer is not provided with information allowing for the identification of the supplier.

39. The computer-based method of claim 31 comprising the step of the supplier providing a payment for the output.

40. The computer-based method of claim 31 comprising the step of providing means for the supplier to provide a payment for the output.
